(19) United States
(12) Patent Application Publication
(10) Pub. No.: US 2006/0286531 A1
(43) Pub. Date: Dec. 21, 2006

(54) Systems and methods for selecting audience members

(76) Inventors: Darin Beamish, Puyallup, WA (US); Matthew Owings, Puyallup, WA (US)

Correspondence Address: David Chen;DWC Law Firm, P.S., PO Box 3041, Seattle, WA, 98114-3041, US

(21) Appl. No.: 11/155,080

(22) Filed: Jun. 18, 2005

(51) Int. Cl. G09B 7/00; A63F 9/24

(52) U.S. Cl. 434/323; 463/9

(57) ABSTRACT

Methods and systems of picking audience members using probability adjustments entered manually by users or generated as a function of audience member information. Methods and systems for assigning audience members in groups are also provided.

### BACKGROUND OF THE INVENTION

1. Field of the Invention

The present invention relates generally to audience grouping and selection methods and systems for use in audience environments and audience environments where electronic remote communications devices are used.

2. Description of Related Art

Teaching professionals often use electronic tools of various types in classrooms and other audience environments to help improve efficiency and accuracy in lessons, to track audience performance, and to otherwise help improve the quality of the audience's learning experience. Audience response systems (also referred to as “audience participation systems”) comprising individual keypads usable by audience members to respond to inquiries or otherwise participate by sending electronic transmissions, are an example of such electronic tools. Such systems have been proven to have wide ranging applicability in many different audience environments, including, for example, presentations delivered in business settings, elementary school classrooms, and university level classrooms. Also, various software applications are used live in audience environments (with or without audience response systems), such as, for example, very popular forms of presentation software used to help create and deliver slide presentations that can be electronically displayed to audience members.

As the use of electronic teaching and presentations tools continues to grow, users become more effective in their implementation and continue to seek out new ways to further integrate such tools into audience environments to increase effectiveness and efficiency.

### BRIEF SUMMARY OF THE INVENTION

Some embodiments of the present invention comprise a computer implemented method of picking audience members to respond to inquiries (also referred to herein as a pick function) wherein the pick function can have randomizing characteristics that can be influenced or adjusted by a user, such as a presenter, to adjust pick probability for any given audience member. Such adjustments can be made live during audience participation or prior to use in an audience environment, or can be made in an automated fashion as a function of individual audience information, such as, without limitation, historical performance data for the individual audience member.

The pick function can be activated selectively by a presenter while in an audience environment. The picked audience member can then be displayed to the audience or to a presenter (such as a teacher) via an electronic display device. Thus, the picked audience member can be notified directly by the electronic display, or can be notified by the presenter verbally.

In further embodiments of the present invention, the adjustable pick function is used with an audience response system comprising remote response units with keypads (portable units) usable by audience members to wirelessly transmit responses to inquiries to be processed by a processing unit and/or stored electronically by computer or other device. The portable units can have individual dedicated display devices on which users, such as presenters and audience members, can view pick function information, such as, without limitation, identifying information of a picked audience member or adjustments to pick probability of an audience member. In some embodiments, the pick function information for a particular audience member is transmitted to only a portable unit held by the particular audience member to be displayed on a dedicated display device thereof, so that the user can view the information privately.

In yet further embodiments of the present invention, performance-based grouping of audience members is conducted using a processing unit, also referred to hereinafter as a grouping function. Audience member performance is tracked in relation to inquiries (or questions) they have responded to historically. A presenter can conduct a team based or group based activity with an audience, and require the audience members to engage in the activity in groups. The groups can be assigned using the grouping function. The grouping function can be based on historical performance of individual audience members.

### BRIEF DESCRIPTION OF SEVERAL VIEWS OF THE DRAWINGS

FIG. 1 is a diagram showing major components of an embodiment of the audience response system of the present invention.

FIG. 2 is a plan view of a portable unit (response unit) for use with some embodiments of the present invention.

FIG. 3 is a simplified block diagram of an embodiment of the portable unit of FIG. 2.

FIG. 4 is a simplified block diagram for a computer, such as a PC, usable with some embodiments of the present invention.

FIG. 5a illustrates an embodiment of a display mode from a graphical user interface, displaying a list of audience members from which a user can select an individual audience member for which to display a second display mode, such at that in FIG. 5b, associated with the selected individual audience member only.

FIG. 5b illustrates a graphical user interface for some embodiments of the present invention usable to adjust or influence a pick probability for an individual audience member.

FIGS. 6a and 6b show a flow chart of a method for executing a pick function of some embodiments of the present invention.

FIGS. 7a and 7b show a graphical user interface for use in creating groups of audience members for some embodiments of the present invention. FIG. 7a illustrates an automatic grouping mode while FIG. 7b illustrates a manual grouping mode.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available structures, hardware, software instructions and wireless protocols associated with wireless communication in audience response systems have not been described in detail to avoid unnecessarily obscuring the descriptions of the embodiments of the invention.

Various embodiments of the present invention are described herein for illustrative purposes only, in the context of a radio frequency (RF) communications link. However, as those skilled in the art will appreciate upon reviewing this disclosure, other manners of carrying wireless communication signals may be suitable, such as, for example, those utilizing infrared (IR) signals. Various embodiments of the present invention are described herein for illustrative purposes only in the context of a teacher and classroom audience, however, as those skilled in the art will understand after reviewing this disclosure, the embodiments of the present invention have wide applicability in other audience and instructional settings, such as, for example, in business settings such as corporate training, or for conducting surveys or presentations.

The terms “audience member,” “student” and “user” are used herein in an interchangeable sense to describe persons using a remote response unit or portable unit for communication within the audience response system disclosed herein, unless the context indicates otherwise. The terms “monitor,” “display device,” “display,” “LCD,” “liquid, crystal display,” and “screen” may be used herein in an interchangeable sense to describe elements usable for electronically displaying data, unless the context indicates otherwise. The term “portable unit” is also used interchangeably with the term “response unit” unless the context indicates otherwise. The term “inquiry” as used herein, can refer to any inquiry or question designed to solicit a response from a user, including, without limitation, surveys, tests, and questions of all types and categories, unless the context indicates otherwise.

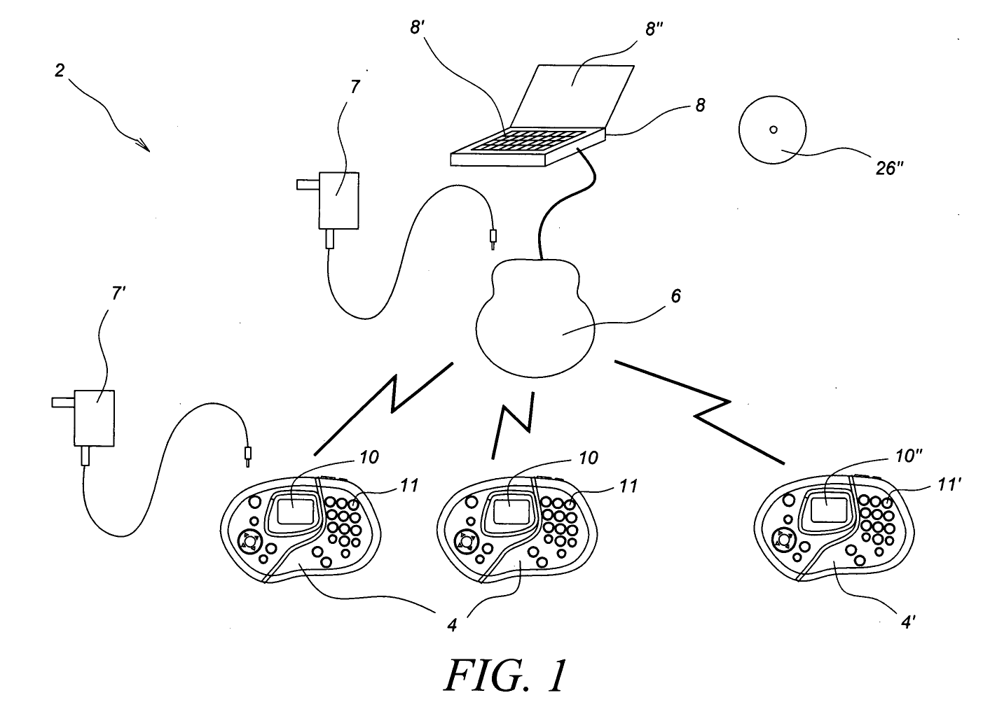

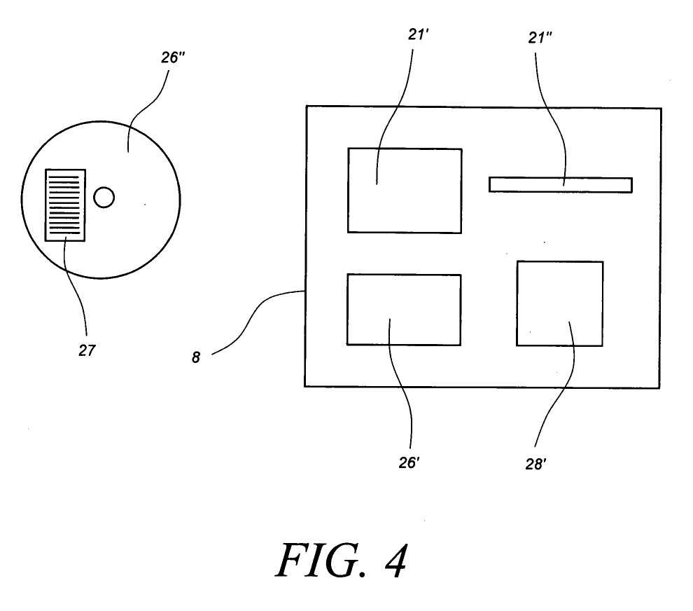

In some embodiments of the present invention an audience response system 2 is provided, having one or more portable units 4 and a host unit 6, as can be seen in FIG. 1. The portable units 4 can include a presenter device 4′, which can have the same or similar structure and system components as the other portable units 4, except that it may be pre-associated to have certain access rights to functions of the audience response system 2 that are not accessible to users of the other portable units 4. The host unit 6 may be communicatively connected to a processing unit or processor, such as within a computer 8, including, for example, a laptop or desktop PC, normally having a keyboard 8′, mouse or other electronic pointing device (not shown) and monitor or other display 8″. Referring to FIG. 4, in embodiments of the present invention where a computer 8 is used, the components of the computer 8 can include, without limitation, a CPU or processor 21′, hard drive 26′ or other non-volatile memory, RAM 28′ and a reading device 21″ for reading instructions or data from a computer readable medium 26″. The computer readable medium 26″ can be, without limitation, floppy disks, CD-ROM disks, tapes, flash memory, system memory, DVD-ROM, external hard drives or any type of portable medium used to store code for use in instructing the processing unit or processor 21′.

Various software applications can be executed with the audience response system 2 using the computer 8 and its associated components. In some embodiments, electronically-readable-instructions 27, such as code, for executing methods of teaching, presenting, or surveying, are provided and can contain instructions or code for execution within the computer 8, with all or portions of the electronically-readable-instructions 27 being storable on the hard drive 26′. The electronically-readable-instructions 27 can also be provided on an external computer readable medium 26″ for use in the reading device 21″, and for upload to the computer 8. In other embodiments, the electronically-readable-instructions 27 are used without some of the audience response system 2 components, as discussed further herein.

A wireless communication link is provided between the portable units 4 and the host unit 6 using infrared or radio frequency methods, structures, systems and related protocols, as will be appreciated by those skilled in the art after reviewing the present disclosure. For example, without limitation, in some embodiments, wireless infrared communication is employed between the portable units 4 and host unit 6 using a signal polling method, while in other embodiments of the present invention, wireless radio frequency (RF) communication is employed, such as, for example, by use of an IEEE 802.15.4 compliant communications link, as will be appreciated by those skilled in the art after reviewing this disclosure.

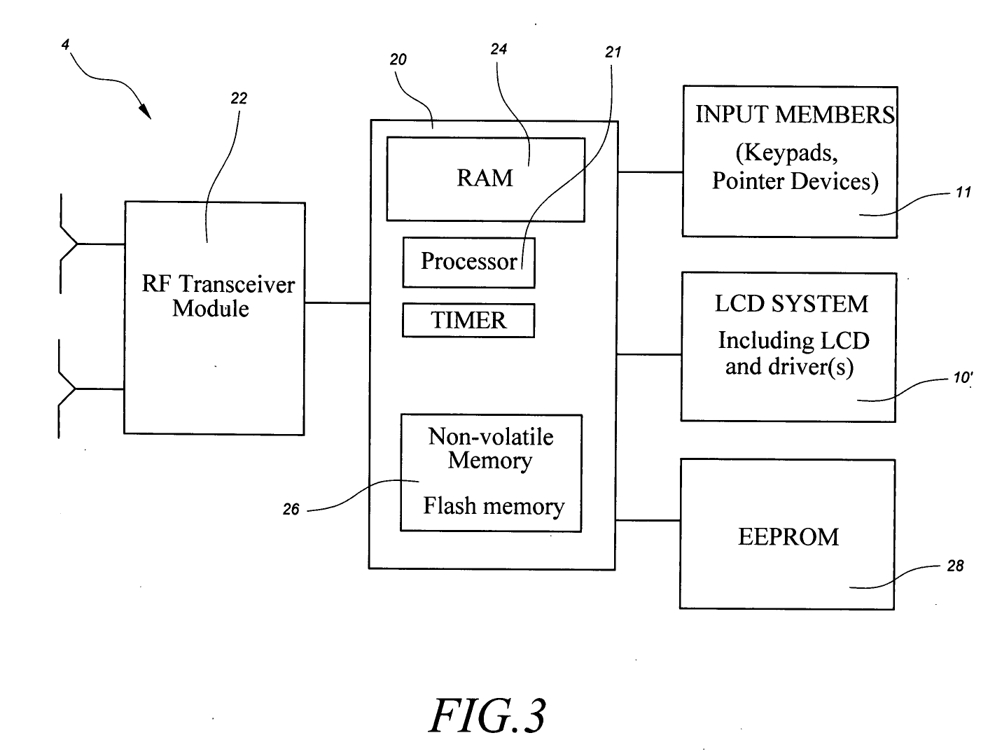

Various embodiments of the portable units 4 can be provided including that illustrated as a simplified block diagram in FIG. 3, which can comprise a display (LCD) system 10′ (such as a liquid crystal display system with driver), input members 11 (e.g. manually operable input members such as, without limitation, keys, buttons, switches and pointers), a RF transceiver unit or module 22 and a microcontroller 20 having a processor or processing unit 21, along with integral or peripheral RAM 24, writable non-volatile memory 26, such as flash memory, and programmable read only memory, such as, for example, EEPROM 28.

The host unit 6 of FIG. 1 may be a full function device or connected to a full function device. The host unit 6 comprises communications components for sending and/or receiving wireless signals to the portable units 4, such as, without limitation, an RF module. The RF module can be coupled to a microcontroller or processor, with the RF module and controller comprising same or similar hardware components as the portable units 4. In addition, the host unit 6 can be coupled to the personal computer 8 or other processing unit (or can contain a sufficient processing unit in itself) for supplying more sophisticated processing power for processing input data entered into the portable units 4 and for executing specific applications software, such as the electronically-readable-instructions 27. In embodiments where the host unit 6 itself comprises such a processing unit 21′, with additional memory components, it may be capable of substituting for the computer 8 in the audience response system 2, as will be appreciated by those skilled in the art after reviewing this disclosure.

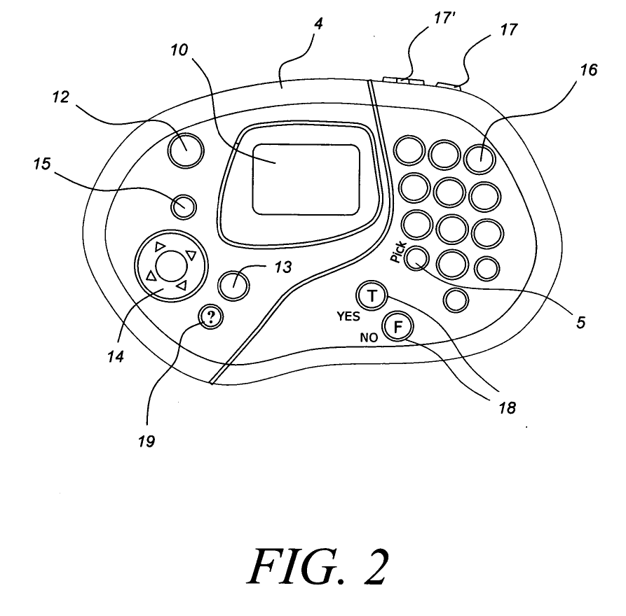

Referring to FIG. 2, some embodiments of the portable unit 4 have various manually operable input members 11, which can include input members 5, 12, 13, 14, 15, 16, 17, 17′, 18 and 19, including a multidirectional cursor key 14 and an alphanumeric keypad 16. Some input members 11 can be multifunctional, and configured to be operable in different modes, as will be appreciated by those skilled in the art after reviewing this disclosure. Designated keys (such as PICK key 5 & T/F/YES/NO key 18) can be provided and signified by one or more types of permanent markings on the keys or a surface of the portable module 4, such as, for example, “YES” or “NO,” “RIGHT” or “WRONG,” or “T” or “F” (signifying “TRUE” or “FALSE” in some embodiments) markings to simplify action required by a user to input responses to certain types of inquiries posed within the audience response system 2. The designated keys can also be provided to simplify initiation of functions, such as, for example, a designated PICK key 5 for selecting or picking certain audience members to communicate with, to receive communications from, or to respond to inquiries (as discussed in further detail below).

The multidirectional cursor key 14 can be used to input information to the microcontroller 20. This can include scrolling through menu systems, or response parameters or selections displayable on a display 8″, 10 (e.g., select icons or menu selections, multiple choice selections in inquiries, true/false selections, yes/no selections, etc.). The displays for such selections can be in the form of a user interface, which can be a graphical user interface (GUI). Alternatively, or in conjunction with the multidirectional cursor key 14, the alphanumeric keypad 16 and other input members 11 can also be used to provide user input.

Referring to FIG. 4, in some embodiments, electronically-readable-instructions 27 can be executed by the computer 8 to define an application environment within which users of the audience response system 2 communicate using the portable units 4 and host unit 6. In other embodiments of the present invention, no portable units 4 are used by audience members and audience members respond conventionally on paper or verbally in the audience environment. The electronically-readable-instructions 27 can define and be used to operate, among other things, a graphical user interface (GUI) for operating the audience response system 2 and various GUI modes for the dedicated displays 10 of the individual portable units 4. The electronically-readable-instructions 27 can also be used to operate various activities implemented using the audience response system 2.

In some embodiments of the present invention, the audience response system 2 is used in a teaching environment, such as a classroom or other instructional or educational setting. A user can preprogram questions or inquiries to be posed to audience members using a GUI via the computer 8. The questions can then be posed to the audience members, such as by being displayed on a commonly viewable display device 8″ (such as the monitor of the computer 8 or other external display device, such as a projection screen with luminous projector) or transmitted via the host unit 6 to one or more portable units 4 to be displayed on the dedicated display devices 10 thereof. Users or audience members can respond to the question posed by actuating one or more of the input members 11 using a portable unit 4.

An inquiry posed may be in any of various forms. For example, in some embodiments, the inquiry requires a numerical response (e.g., a math problem requiring a numerical solution). Depending on form of inquiry or question, users may respond using the alphanumeric keypad 16 or by selecting one of the designated keys 18, or in some embodiments, users may respond using the multidirectional cursor key 14 to scroll through various selectable answers presented on individual display devices 10 of the portable units 4.

In some embodiments of the present invention, when posing inquiries using the audience response system 2 or some of its components, such as the computer 8, it may be desirable to call on, or otherwise “pick,” selected audience members to respond to inquiries and to display the responses from those audience members to the entire audience, or to otherwise process such responses exclusive of, or differently from, responses of other audience members. For example, a presenter, such as a teacher, can instruct the processing unit 21′ to execute a pick function that picks one or more audience members at random (or pseudo randomly), or based on a particular set of conditions. Identifying information for each of the audience members can be pre-stored within a memory 26′, as will be appreciated by those skilled in the art after reviewing this disclosure. The pick function, which can be provided as part of the electronically-readable-instructions 27, can instruct the computer 8, or processing unit 21′, to execute a pseudo random computation, to select a particular audience member to respond to an inquiry.

A presenter or teacher can selectively execute the pick function using a key on the computer keypad 8′, after which, the picked audience member can be displayed on a commonly viewable display or on dedicated displays 10 of the portable units 4. The presenter may use an input member 11 on the presenter device 4′, such as a PICK key 5, to send a wireless signal to the computer 8 via the host unit 6, to activate the pick function. In such embodiments, the presenter can move about a space, such as a classroom, while activating the pick function selectively.

A picked audience member may be required to enter a response using an input member 11 on a portable unit 4. In some embodiments of the present invention, during certain activities (such as, for example, a teaching session with spontaneous questions being asked, or a set of questions being presented during a class session or other presentation session), only a picked audience member is permitted to respond using her/his portable unit 4, while responses transmitted by other audience members using portable units 4, are ignored by the processor 21′, or processing unit. The picked audience member's response may be used for unique actions, such as to be displayed on a commonly viewable display 8″ to all audience members, or to be otherwise uniquely processed as input data through a function executed by the processor 21′. In other embodiments of the present invention, even though an individual audience member has been picked, all responses transmitted by audience members are processed by processing unit 21′, while the picked audience member's response is uniquely processed, such as, for example, by being the only response displayed commonly to all audience members.

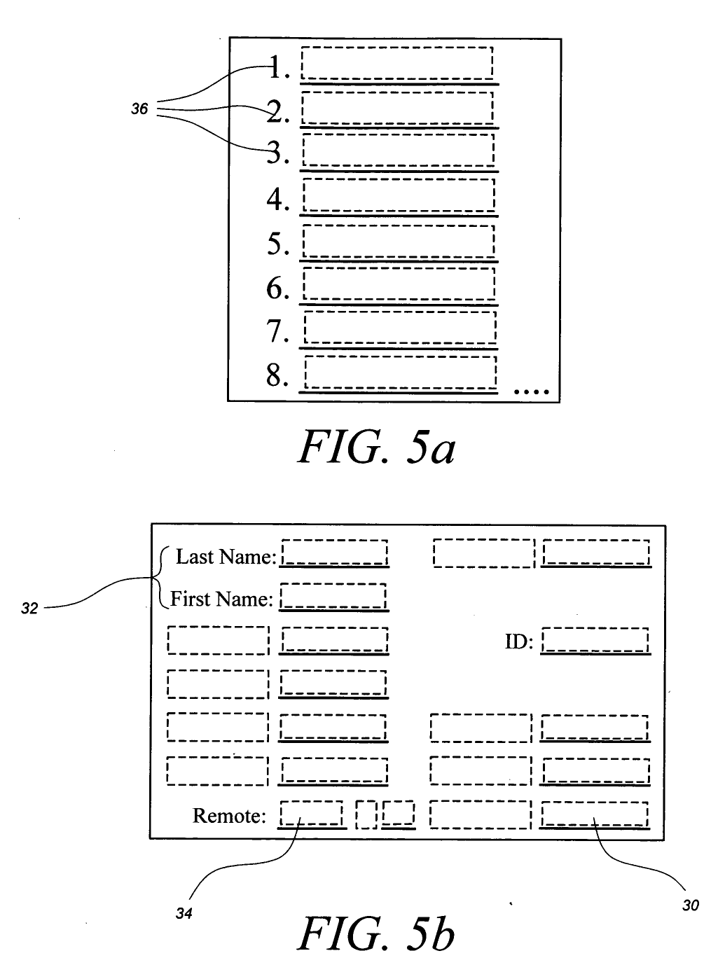

In further embodiments of the present invention, the probability that a particular audience member is chosen by the pick function can be influenced or adjusted to increase or decrease a pick probability for that particular audience member. For example, in a first mode of a GUI shown in FIG. 5a, displayable on the computer display 8″, a list of known and preprogrammed audience member names, and/or other identifying information 36 is shown. A presenter can use the GUI mode of FIG. 5a to select an audience member from the list. The same, or an additional GUI mode, can then displayed, as shown in FIG. 5b, which can include fields 30, 32, 34, specific to the individual selected audience member. This GUI mode of FIG. 5b can be used to adjust the probability of selected audience member to be picked (or “called on”) using the pick function. Field 30 can be provided for making such adjustment. The audience member identification can also be displayed in field 32. Also, the particular audience member can be pre-associated with a particular portable unit 4 identified in field 34, in embodiments where portable units 4 are used.

In some embodiments of the present invention, a numerical setting of one (1) in field 30 is a “normal” setting, wherein the pick function is set at a baseline value with respect to the probability that the particular audience member 32 will be selected. As those skilled in the art will appreciate after reviewing this disclosure, the baseline probability of being picked will depend on a particular algorithm employed for the pick function, which can be a pseudo random computation executed by the processing unit 21′. Also, in some embodiments of the present invention, a numerical settings in field 30 for each individual audience member can impact pick probability for that audience member in approximate accordance with the following: [Numerical Setting of Individual Audience Member DIVIDED BY Total of Numerical Setting for all Other Audience Members EQUALS Probability of the Individual Audience Member Being Picked].

In such embodiments, a numerical setting of zero (0) can result in the absence of any probability for the individual audience member 32 to be picked via the pick function. A zero (0) setting can be used when it is desirable to avoid picking certain audience members, such as when an audience member may be extremely versed in a particular subject matter and the presenter would like to engage with other audience members to facilitate learning. A zero (0) setting might also be used to avoid picking an audience member that might be offended or embarrassed by being picked.

Without being bound by theory, as will be appreciated by those skilled in the art, the adjustment of pick probability for one audience member to be picked can impact the probability that other audience members will be picked. Thus, in some embodiments, the probability of being picked associated with a baseline selection in field 30 for any given audience member, may be affected upward or downward, depending on the adjusted probability settings for other audience members; however, individual settings can still influence pick probability for individual audience members.

In other embodiments of the present invention, the pick function can be adjustable based on associations with audience lists. For example, in some embodiments, a plurality of lists, each list identifying one or more audience members, are pre-generated for use with different types of activities or inquiries. Different lists of audience members can be used depending on the particular activity or inquiry posed. Some activities or questions having inquiries to be displayed electronically are stored with associations to designated lists of audience members. In this manner, when an activity or inquiry is posed using the audience response system 2 or computer 8, the processor 21′ can examine whether a designated list of audience members has been associated with the activity or inquiry, and if so, to limit the pick function to pick only audience members identified within the designated list or lists. Also, in this manner, probability adjustments are made to the pick function, in part, by using different lists depending on the adjustment, thereby eliminating any possibility that certain audience members will be picked for certain activities or inquiries.

In other embodiments of the present invention, the pick function can be used with or without various audience response system 2 components, such as without portable units 4 or a host unit 6, or any wireless transmission device or system, wherein the presenter uses the computer 8 to execute the pick function. The presenter can execute the pick function, to pick an audience member to respond verbally to an inquiry, or otherwise pick an audience member with which to engage, regardless of whether the audience member is using a portable unit 4.

The pick function can also be used in a manner that only provides an output to the presenter, indicating a picked audience member privately to the presenter. The presenter can then verbally convey to the audience which audience member is picked. This can be especially useful in circumstances wherein the pick function is influenced by audience performance, as described further below.

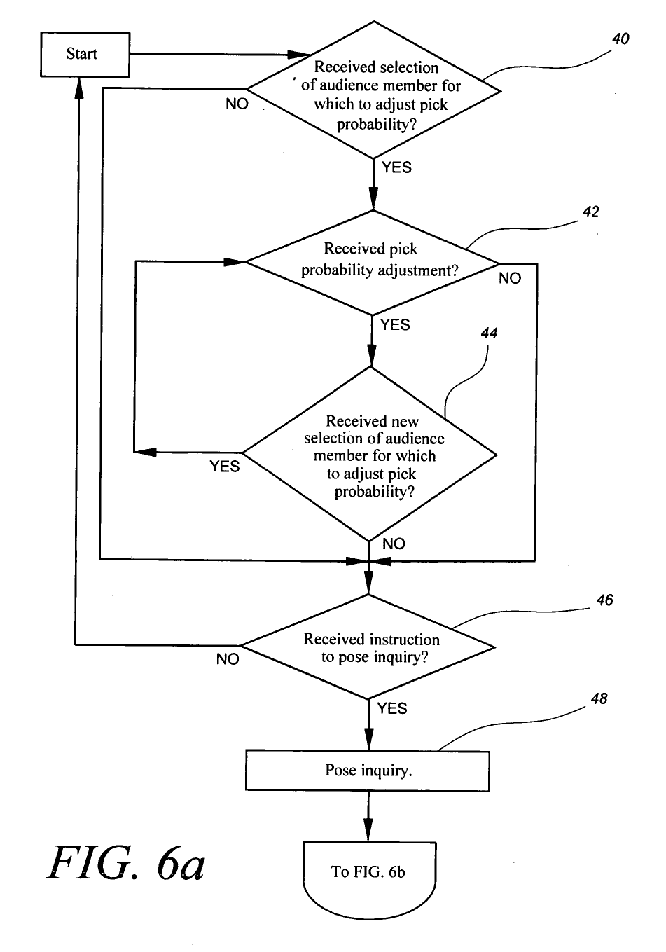

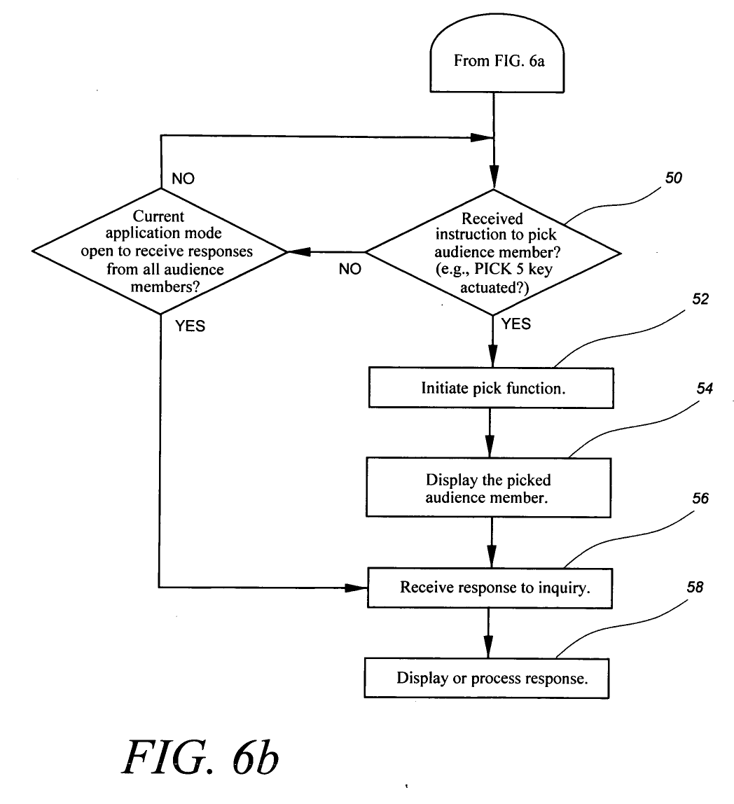

Referring to FIG. 6a and 6b, an example embodiment of an electronically implemented method of picking an audience member for use in various embodiments of the audience response system 2 is illustrated. In FIGS. 6a-6b, the embodiments illustrated involve use of wireless transmission or receiving devices, such as the portable unit 4 and a host unit 6. At step 40, the processing unit 21′ waits to receives instruction to select a particular audience member for which to adjust a pick probability. The selection can be accomplished in the GUI mode in FIG. 5a, wherein an instructor can select the audience member by using a pointer. The pick probability adjustment can then be received at step 42 for the selected audience member. The adjustment can be made in the GUI mode of FIG. 5b by entering an adjustment factor in field 30, such as, for example, in a manner previously described. These steps can be repeated for other audience members, as shown in step 44. An instruction can then be sent to the computer 8 to pose an inquiry, which can be displayed on a display device 8″, 10 or transmitted by sound via speakers (not shown), in steps 46 and 48. The instruction to pose a particular inquiry in step 46 can be initiated by the presenter or can be partially or fully automated in the context of a variety of preprogrammed activities, such as, for example, in the context of a set of preprogrammed instructions for delivering a presentation or quiz having inquiries to be posed to audience members. Audience members can then respond to the inquiries using the portable units 4. A presenter can initiate the pick function at step 52 in FIG. 6b, by actuating a PICK key 5. The audience response system 2 can then cause identifying information about the picked audience member to be displayed at step 54, such as on the display device 8″ of a computer 8, other external display device, or on individual display devices 10 of the portable units 4. The picked audience member is displayed to the entire audience, or privately to a presenter or to individual audience member(s). Thereafter, when the picked audience member receives notification that she or he is picked, the audience member can respond to the inquiry by using one or more of the input members 11 of a portable unit 4. The response can be received and displayed or otherwise processed at steps 56 and 58 by the computer 8.

In some embodiments of the present invention, wherein the picked audience member is displayed only to the presenter, such as through the display 10 of a presenter device 4′, or through a computer monitor 8″ viewable only by the presenter, the presenter will have an opportunity to decide whether to call on the picked audience member, and then to verbally call on the audience member, or to select to display the audience member's name to the audience.

In further embodiments, wherein the portable units 4 have dedicated displays 10, audience members can privately view when they are picked by the pick function on their own dedicated displays 10, and choose whether to respond. Also, audience members may privately view adjustments to their own pick probabilities on the dedicated display devices 10 or the portable units 4. Without limiting intent, it is noted that these embodiments can be desirable where a presenter or teacher wishes to notify audience members that they are picked without placing audience pressure on them, or when the presenter wishes for an audience member to know when they should be especially prepared for being called upon or otherwise picked, because the audience member's pick probability adjustment is high. Furthermore, audience members can be provided with the ability to privately adjust their own pick probability using the portable unit 4 to transmit adjustments to the processing unit 21′. The dedicated display device 10 of the portable unit 4 can be used to privately and visually verify adjustments made. Also, in other embodiments, audience members can privately adjust the pick probability of other audience members using their portable units 4, and again use the dedicated display devices 10 thereof to privately and visually select audience members for which such adjustments are to be made and to verify the adjustments.

In further embodiments of the present invention, the probability of certain audience members being picked (e.g., pick probability) can be adjusted as a function of audience member performance parameters or other audience member specific information, which can be tracked using the audience response system 2, and stored on a memory 26′ of the computer 8, or other non-volatile memory, as will be appreciated by those skilled in the art upon reviewing this disclosure. For example, in a student-teacher environment, the audience response system 2 can be configured to track student performance on particular questions or question categories, types or levels. In some embodiments, question categories can be subject matter categories (e.g., math questions, English questions, history questions, science questions, etc.). Question types can be, for example, areas within the subject matter (e.g., linear equations, math story problems, spelling, grammar, era of history, etc.). Levels can be assigned to certain questions based on teaching standards criteria or based on internal rating systems for a particular classroom defined by a teacher. Thus, a particular student's performance based on responses to questions provided using the audience response system 2 or otherwise stored on memory 26′, is tracked and rated according to specific questions, question type, question category or question level. In some embodiments of the present invention, in order to use such tracked data, the individual questions posed using the audience response system 2 or computer 8 can be pre-associated with a category, type or level so as to be matchable with a students rating on the particular category, type or level.

For illustrative purposes, an example is provided: A particular question can be posed. The processor 21′ can examine a question category of the particular question posed, which can be provided to the processor 21′ by a teacher, or preprogrammed in association with the question posed. The processor automatically adjusts pick probability of all students as a function of history of performance of the students tracked according to question category. This history of performance used to make the adjustments can be predefined for a certain period of time, such as all data available for the past week of class. Based on that data, the history of performance can be rated according to a numerical ranking in the class for that week for each student. The numerical ranking is then used as a probability adjustment factor, or inversely as a probability adjustment factor. For example, if a student's history performance on a particular question category is lower on the ranking, that student's chance of being picked can be adjusted upward automatically, while the pick probability for a student that has a higher ranking, may be adjusted downward automatically. As will be appreciated by those skilled in the art after reviewing this disclosure, various other algorithms or functions can be implemented to make such adjustments as a function of student historical performance. Similar automated adjustments to pick probability of audience members can be implemented in a variety of other audience environments where the probability of an audience member being picked using a pick function is adjusted as a function of individual information related to particular audience members.

In some embodiments of the present invention, other performance-based selections of audience members are implemented. Certain activities conducted using the audience response system are conducted in groups of audience members. For example, without limitation, in some settings educational games are executed using the audience response system 2 with students grouped in teams. Questions can be posed by being displayed on display device 8″, 10 as a part of the games. Students in the groups can confer with one another prior to responding to questions using input members 11 of the portable units 4. The students can take turns responding to questions on behalf of their assigned groups. In other embodiments of the present invention, teachers can execute an embodiment of the pick function (such as those described previously) to pick a students from a groups to respond.

In such embodiments involving groups, or any other audience settings involving groups or teams, it can be desirable to have students (or other types of audience members) grouped by historical performance to balance the strength of groups. In alternative embodiments, students having similar strength levels can be assigned to the same groups. This can be desirable in some circumstances, such as for group instruction purposes wherein teachers can provide all members of a particular group the same difficulty of lesson, quiz or test.

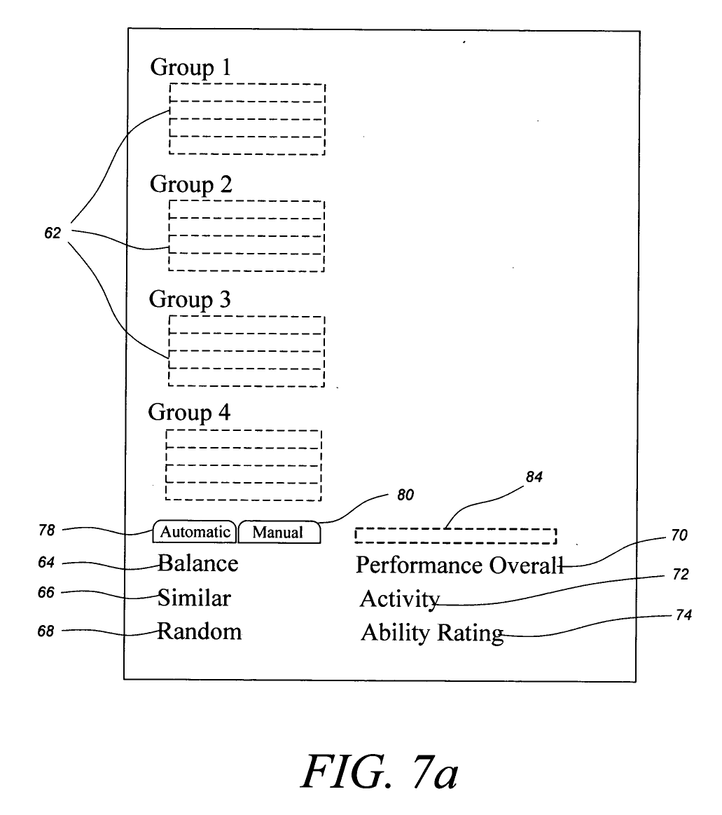

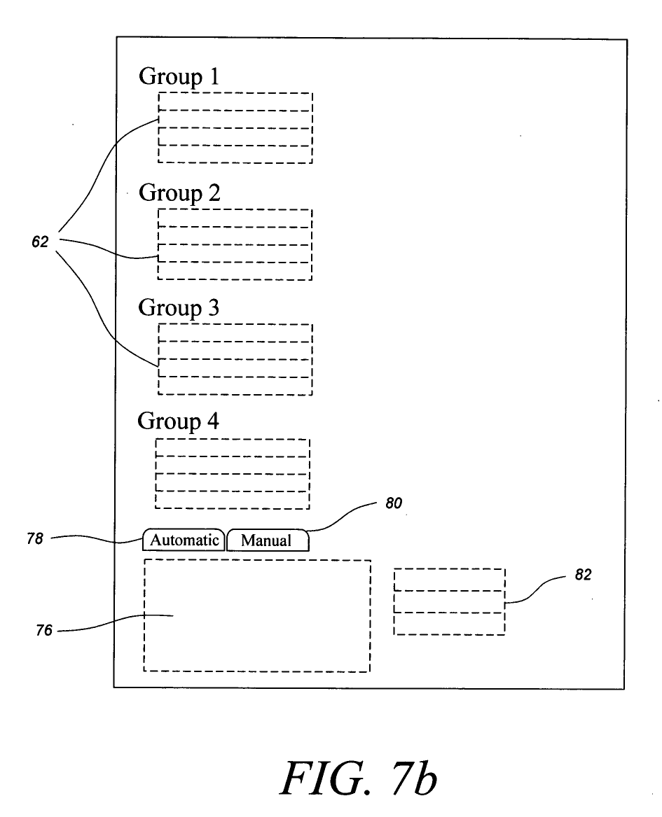

A teacher can elect to execute an automated grouping function that can be an application component of the electronically-readable-instructions 27, executable on the computer 8. To do so, a teacher or presenter can select a particular GUI mode, such as that shown in FIGS. 7a & 7b, wherein groups of students are identified in fields 62. Within the GUI mode, an automatic mode 78 can be selected, as shown in. FIG. 7a, usable to initiate an automatic grouping function. The automatic grouping function can be based on, among other things, activity performance of students. The automatic mode shown in FIG. 7a can display a plurality of selectable options, including “balance” 64, which balances groups based on performance by grouping students with stronger performance history with students having weaker performance history, in each group; “similar” 66, which groups students with similar performance together; and “random” 68, which groups students using an algorithm that is independent of student performance history, as will be appreciated by those skilled in the art after reviewing this disclosure. When the “balance” 66 or “similar” 66 option is selected, a user can also select what type of performance history is used to achieve the balanced or similar grouping. The selectable options for performance history to use can include: overall performance 70, which can be a student's performance history over a group of activities; activity performance 72, which can be a student's performance for a specific activity (e.g. a test or quiz) or certain type of activity; and ability rating 74, which can be preset by a teacher as a numerical rating, based on information the teacher has, or otherwise based on judgment of the teacher or presenter. After a selection is made, the grouping function can automatically create groups of students, such as those identified in fields 62 in FIG. 7a and 7b, as a function of the selections above.

The “balance” option can balance student groups by various algorithms, as will be appreciated by those skilled in the art after reviewing this disclosure. However, in one example, indexes or ratings are calculated for individual students by processor 21′ using the following method: The indexes can be grades for a particular activity, or be ratings from 1-10, or any other index system that is approximately proportional to a student's relative performance in comparison with other students. The balance option instructs the processor 21′ to receive the number of groups to be created and the number of students in each group, and then to select a student for each group starting from the highest indexed student, and moving downward, distributing one student to each group. The processor 21′ then picks a next set of students to be distributed to the groups by starting from the lowest indexed student, moving upward, until each group has a second student. The processor 21′ then again distributes students sequentially starting from the top indexed student among the remaining unselected students and after that, against starts from the bottom of the remaining unselected students and so on until all groups are fully assigned.

In the manual mode shown in FIG. 7b, a user can actuate options to manually add or remove students into groups shown in fields 62.

In some embodiments of the present invention, the balance or similar options are executed automatically depending on an activity mode of the computer 8 or audience response system 2.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices, systems and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. An audience response system comprising:
a host unit;
a plurality of portable units for transmitting wireless responses to the host unit; and
a processing unit communicatively connected to the host unit and capable of executing a pick function to pick an audience member to respond to a question, wherein the pick function is adjustable to adjust the probability of at least one audience member to be picked.

2. The audience response system of claim 1 wherein said pick function is adjustable by a user for increasing or decreasing a probability of an audience member to be picked.

3. The audience response system of claim 1 wherein adjusting the pick function comprises selecting a pre-designated list of audience members from which to pick an audience member to respond.

4. The audience response system of claim 1 further comprising a display device provided on at least one of the portable units as a dedicated display device for the portable unit.

5. The audience response system of claim 1 wherein the portable unit is configured to permit a user to adjust said probability using the portable unit.

6. The audience response system of claim 1 wherein the processing unit is further configured to be capable of adjusting the probability as a function of past performance of the at least one audience member.

7. The audience response system of claim 6 wherein said adjustment is made as a function of an inquiry category or inquiry type of a current inquiry posed in the audience response system.

8. The audience response system of claim 6 wherein said adjustment is made as a function of past performance on the same inquiry currently posed.

9. The audience response system of claim 1 wherein the pick function comprises a pseudo-random computation executed by the processing unit.

10. The audience response system of claim 1 wherein adjustment can be made by selecting a number on a graphical user interface and wherein the probability of the at least one audience member of being picked is approximately equal to the number divided by a total of numbers selectively assigned to all other participating audience members.

11. The audience response system of claim 1 wherein said probability can be decreased to zero.

12. A method of selecting an audience member to respond to a question posed in an electronic audience response system environment comprising a plurality of handheld remote response units usable by audience members to respond to inquiries, the method comprising:
receiving at a processing unit in wireless communication with the handheld remote response units, an adjustment usable for adjusting the probability of picking an audience member to respond to a question;
receiving at the processing unit an instruction to display a question;
displaying the question on a display device;
receiving at the processing unit, an instruction that instructs the processing unit to execute a pick function to pick an audience member; and
displaying the picked audience member on a display device.

13. The method of claim 12 wherein the instruction is wirelessly transmitted to the processing unit from a portable unit.

14. The method of claim 12 wherein the pick function comprises a pseudo random computation usable for a establishing a baseline probability for picking an audience member, with said pseudo random computation being adjustable by the adjustment.

15. The method of claim 12 further comprising receiving a plurality of adjustments for adjusting the probability of being picked for a plurality of audience members, each adjustment being used for a different audience member.

16. The method of claim 12 wherein the adjustment is generated by the processing unit as a function of historical performance of the audience member.

17. The method of claim 16 wherein the historical performance is performance of the audience member in relation to a question category or question type substantially similar to a question category or question type of a question to be displayed.

18. A computer implemented method of grouping audience members for activities, the method comprising:
recording audience member performance with respect to activities; and
grouping the audience members in groups as a function of said audience member performance, said grouping being capable of being initiated by a function executable by a processing unit of the audience response system.

19. The method of claim 18 wherein grouping the audience members comprises grouping the audience members as a function of audience member performance on a single activity.

20. The method of claim 18 wherein grouping the audience members comprises grouping the audience members as a function of audience member performance on a plurality of activities.

21. The method of claim 18 further comprising grouping the audience members to balance performance levels of audience members in each group.

22. The method of claim 21 wherein balancing performance levels comprises placing higher performance audience members with lower performance audience members in each group.

23. The method of claim 18 further comprising grouping audience members of similar performance levels in each group created.

24. A computer implemented method of picking audience members to respond to inquiries, the method comprising:
receiving a probability adjustment;
executing a pick function to pick an audience member using the probably adjustment; and
electronically displaying the picked audience member to the audience or privately.

25. The computer implemented method of claim 24 wherein the picked audience member is displayed privately to a presenter on a display device viewable only by the presenter.

26. The computer implemented method of claim 24 wherein identifying information regarding a picked audience member is displayable on a dedicated display device of a remotely located portable unit by wireless transmission to the portable unit.

27. The computer implemented method of claim 26 wherein said identifying information is displayed on the dedicated display device of only one remotely located portable unit, and wherein there are a plurality of remotely located portable units, whereby the picked audience member can be privately informed about being picked.

28. The computer implemented method of claim 24 wherein adjusting a probability with which an audience member can be picked to respond to an inquiry is executed as a function of stored information in relation to the audience member and as a function of a type or category of inquiry being posed.

29. The computer implemented method of claim 28 wherein the stored information is historical performance information related to the audience member.

30. The computer implemented method of claim 29 wherein the historical performance data is performance data of the audience member in relation to a category or type of question that is substantially similar to a category or type of question to be posed to an audience.

31. A computer readable medium for instructing a computer to perform a method of picking audience members to respond to inquiries comprising:
receiving a probably adjustment that is at least one of a function of information related to an individual audience member, a pre-generated list of audience members and a manually entered user selection; and
executing a pick function to pick an audience member as a function of the probably adjustment.

32. The computer readable medium of claim 31 wherein the picked audience member is displayed privately to a presenter on a display device viewable only by the presenter, wherein there are a plurality of display devices usable with the method.

33. The computer readable medium of claim 31 wherein identifying information regarding a picked audience member is displayable on a dedicated display device of a remotely located portable unit by wireless transmission to the portable unit.

34. The computer readable medium of claim 33 wherein said identifying information is displayable on the dedicated display device of only one remotely located portable unit, and wherein there are a plurality of remotely located portable units usable with the method, whereby the picked audience member can be privately informed about being picked.

35. The computer readable medium of claim 31 wherein the information related to the individual audience member is historical performance of the individual audience member on a question category or question type substantially similar to category or type of inquiry being delivered.
